(19) United States
(12) Patent Application Publication
(10) Pub. No.: US 2024/0274916 A1
(43) Pub. Date: Aug. 15, 2024

(54) HEAT DISSIPATION STRUCTURE AND BATTERY MODULE

(71) Applicant: TOYOTA JIDOSHA KABUSHIKI KAISHA, Toyota-shi (JP)

(72) Inventor: Kei AOYAMA, Toyota-shi (JP)

(73) Assignee: TOYOTA JIDOSHA KABUSHIKI KAISHA, Toyota-shi (JP)

(21) Appl. No.: 18/542,079

(22) Filed: Dec. 15, 2023

(30) Foreign Application Priority Data
Feb. 14, 2023 (JP) 2023-020630

(51) Int. Cl. H01M 10/613; H01M 10/6551; H01M 50/204

(52) U.S. Cl. CPC H01M 10/613; H01M 10/6551; H01M 50/204; H01M 10/625; H01M 2220/20

(57) ABSTRACT

A heat dissipation structure includes a battery cell having electrode body and exterior body accommodating the electrode body, a cooler disposed so as to face a bottom surface of the exterior body, and a heat dissipation material disposed between the bottom surface and the cooler, the bottom surface is deformed into a convex shape to a side of the cooler by the heat generated by the electrode body, the heat dissipation material includes a first member and a second member having an elongation higher than the first member, the first member is disposed in a position where the first member contacts at least a top portion of the bottom surface, the second member is disposed in a position where the second member contacts a recess of the bottom surface, the recess has less deformation amount to the side of the cooler than the top portion.

### TECHNICAL FIELD

The present disclosure relates to a heat dissipation structure and a battery module.

### BACKGROUND

A battery pack to be mounted on a vehicle includes a battery module, the battery module includes a plurality of battery cells. A lower surface of the battery cell is cooled by a cooler. The heat dissipating material disposed between the lower surface of the battery cell and an upper surface of the cooler has a role to conduct heat from the battery cell to the cooler. When one battery cell of the plurality of battery cells included in the battery module generates an abnormal heat, in order to suppress the propagation of heat to a battery cell adjacent to the battery cell which generates the abnormal heat, the heat transfer through the heat dissipation material from the battery cell which generates the abnormal heat to the cooler becomes important. In some cases, a load called an external input (for example, a load in front-rear direction of the vehicle) is applied to the battery pack in accordance with the fact that a front guard of the vehicle comes into contact with a ground object such as a curb when the vehicle is moving forward, etc. A heat dissipation material having a predetermined hardness is used in order to suppress the positional deviation of the battery cell with respect to the cooler, for example, in the front-rear direction of the vehicle in the case where the external input is applied to the battery pack.

Patent Document 1 (WO 2015/092889 A1) discloses a curable thermally conductive grease that efficiently transfers heat from a heat-generating body to a heat-dissipating body even when the gap between the heat-generating body and the heat-dissipating body is wide.

In the technique described in Patent Document 2 (JP 2013-080916 A), a plurality of dot-like portions called wafer portions formed by a heat dissipation material having a high content ratio of heat dissipating filler is arranged so that the wafer portions are interspersed in a direction perpendicular to the thickness direction of a sheet (i.e., in a plane direction of the sheet) while, in the thickness direction of the sheet, the plurality of wafer portions are arranged side by side on the same line. That is, in the technique described in Patent Document 2, the plurality of wafer portions is arranged in an island shape in the plane direction of the sheet, at each position of the plurality of wafer portions that are interspersed in the plane direction of the sheet, the plurality of wafer portions is arranged side by side in the thickness direction of the sheet.

In the heat dissipation material of the sheet type such as the technique described in Patent Document 2, since the adhesive property of the heat dissipation material is low, the heat dissipation material cannot follow the expansion of the battery cell when the battery cell generates the abnormal heat, there is a possibility that the heat dissipation material is peeled off from the battery cell. In a curable heat dissipation material such as the technique described in Patent Document 1, since the heat dissipation material is hard and does not extend after the heat dissipation material hardens, the heat dissipation material cannot follow the expansion of the battery cell when the battery cell generates the abnormal heat, there is a possibility that the heat dissipation material is peeled off from the battery cell. As a result, in the technique described in Patent Documents 1 and 2, when the battery cell becomes high temperature, it is impossible to sufficiently conduct the heat generated by the battery cell to the cooler, there is a possibility that the heat dissipation becomes insufficient.

### SUMMARY

In view of the above, it is an object of the present disclosure to provide a heat dissipation structure and a battery module capable of improving the heat dissipation of the battery cell while suppressing the positional deviation of the battery cell.

(1) An aspect of the present disclosure is a heat dissipation structure including: a battery cell having an electrode body and an exterior body configured to accommodate the electrode body; a cooler disposed so as to face a bottom surface of the exterior body; and a heat dissipation material disposed between the bottom surface and the cooler, and being in contact with the bottom surface and the cooler, wherein the bottom surface is deformed into a convex shape to a side of the cooler and the heat dissipation material by the heat generated by the electrode body, the heat dissipation material includes a first member having a first elongation, and a second member having a second elongation higher than the first elongation, the first member is disposed in a position where the first member is in contact with at least a top portion of the bottom surface deformed into the convex shape, the second member is disposed in a position where the second member is adjacent to the first member and the second member is in contact with a recess of the bottom surface, the recess has less deformation amount to the side of the cooler than the top portion.

(2) The heat dissipation structure according to above aspect (1), wherein the first member may have hardness higher than the second member, the first member may have adhesion stronger than the second member.

(3) A battery module including the heat dissipation structure according to above aspect (1), wherein a plurality of battery cells may be arranged side by side, the top portion of each of the plurality of battery cells may be in contact with the first member, the recess of each of the plurality of battery cells may be in contact with the second member.

(4) The heat dissipation structure according to above aspect (1), wherein a ratio of an area of a contact surface between the first member and the cooler to an area of a contact surface between the second member and the cooler may be 4/6 to 6/4.

(5) The battery module according to above aspect (3), wherein the plurality of battery cells may include at least a first battery cell and a second battery cell arranged side by side with the first battery cell, the bottom surface of the first battery cell may include the top portion of the first battery cell, a first recess of the first battery cell located on an opposite side of the second battery across the top portion of the first battery cell, and a second recess of the first battery located on a side of the second battery from the top portion of the first battery cell, the bottom surface of the second battery cell may include the top portion of the second battery cell, a first recess of the second battery cell located on a side of the first battery from the top portion of the second battery cell, and a second recess of the second battery located on an opposite side of the first battery across the top portion of the second battery cell, the first member may include at least a first portion of the first member being in contact with the top portion of the first battery cell and a second portion of the first member being in contact with the top portion of the second battery cell, the second member may include at least a first portion of the second member being in contact with the first recess of the first battery cell, a second portion of the second member being in contact with the second recess of the first battery cell and the first recess of the second battery cell, and a third portion of the second member being in contact with the second recess of the second battery cell.

According to the present disclosure, it is possible to improve the heat dissipation of the battery cell while suppressing positional deviation of the battery cell.

### BRIEF DESCRIPTION OF THE DRAWINGS

FIG. 1 is a diagram showing an example of a battery cell constituting a part of a heat dissipation structure of a first embodiment.

FIG. 2 is a diagram showing an example of the battery cell in a state in which a bottom surface of an exterior body is deformed into a convex shape accompanied with heat generation of an electrode body.

FIG. 3A is a side view showing an example of the heat dissipation structure of the first embodiment in a state in which deformation of the bottom surface of the exterior body accompanied with the heat generation of the electrode body does not occur.

FIG. 3B is a plan view of a heat dissipation material shown in FIG. 3A in which the battery cell is seen through (an outline of the battery cell is indicated by a broken line).

FIG. 3C is a plan view of the battery cell and the heat dissipation material shown in FIG. 3A.

FIG. 4A shows an example of the heat dissipation structure of the first embodiment in a state in which the bottom surface of the exterior body of the battery cell is deformed into the convex shape accompanied with the heat generation of the electrode body of the battery cell.

FIG. 4B shows the heat dissipation structure of a comparative example in a state in which the bottom surface of the exterior body of the battery cell is deformed into the convex shape accompanied with the heat generation of the electrode body of the battery cell.

FIG. 5A is a diagram for explaining an example of the heat dissipation structure of the first embodiment when an external input is applied.

FIG. 5B is a diagram for explaining the heat dissipation structure of the comparative example when the external input is applied.

FIG. 6 is a diagram schematically showing an example of a battery module of a second embodiment.

FIG. 7A shows top portions, recesses, and the like of bottom surfaces of exterior bodies in a state in which the bottom surfaces of the exterior bodies of a plurality of battery cells are deformed into the convex shape accompanied with the heat generation of the electrode bodies of the plurality of battery cells included in the battery module of the second embodiment.

FIG. 7B shows first member, second member, and the like of the heat dissipation material in a state in which the bottom surfaces of the exterior bodies of the plurality of battery cells are deformed into the convex shape accompanied with the heat generation of the electrode bodies of the plurality of battery cells included in the battery module of the second embodiment.

FIG. 8 is a diagram showing a relationship between an area ratio of the first member and a shear adhesion of the first member.

FIG. 9 is a diagram showing a relationship between an area ratio of the second member and a shear adhesion of the second member.

FIG. 10 is a diagram showing a relationship between a contact area retention ratio between the bottom surface of the exterior body of the battery cell and the first member and a heat transfer amount to a cooler via the first member.

### DESCRIPTION OF EMBODIMENTS

Embodiments of a heat dissipation structure and a battery module of the present disclosure will be described below with reference to the drawings.

### First Embodiment

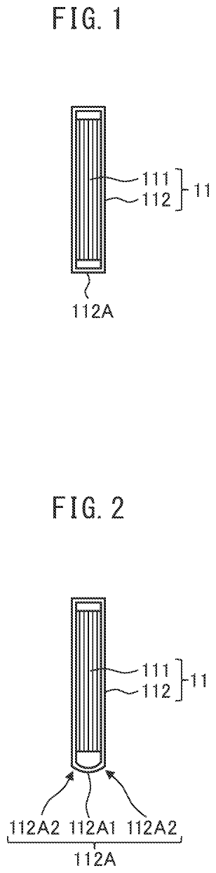

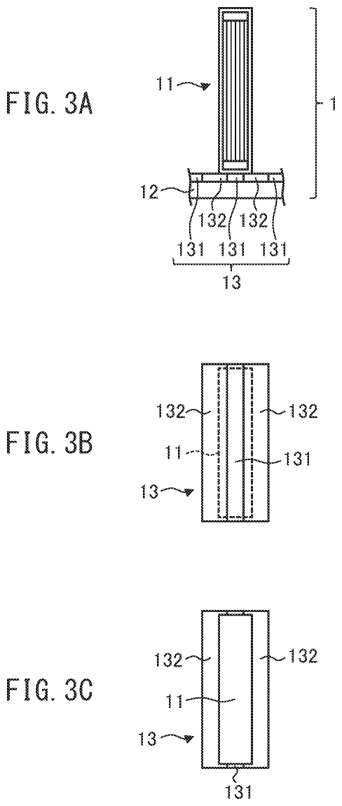

FIG. 1 is a diagram schematically showing an example of a battery cell 11 constituting a part of a heat dissipation structure 1 (see FIG. 3A) of a first embodiment. Specifically, FIG. 1 is the diagram showing the example of the battery cell 11 in a state in which deformation of a bottom surface 112A of an exterior body 112 of the battery cell 11 accompanied with heat generation of an electrode body 111 of the battery cell 11 does not occur. FIG. 2 is a diagram showing an example of the battery cell 11 in a state in which the bottom surface 112A of the exterior body 112 is deformed into a convex shape accompanied with the heat generation of the electrode body 111. FIGS. 3A to 3C are diagrams schematically showing an example of the heat dissipation structure 1 of the first embodiment. Specifically, FIG. 3A is a side view showing an example of the heat dissipation structure 1 of the first embodiment in a state in which the deformation of the bottom surface 112A of the exterior body 112 accompanied with the heat generation of the electrode body 111 does not occur. FIG. 3B is a plan view of a heat dissipation material 13 shown in FIG. 3A in which the battery cell 11 is seen through (an outline of the battery cell 11 is indicated by a broken line). FIG. 3C is a plan view of the battery cell 11 and the heat dissipation material 13 shown in FIG. 3A.

In the examples shown in FIGS. 1 to 3C, the heat dissipation structure 1 of the first embodiment includes the battery cell 11, a cooler 12, and the heat dissipation material 13. The battery cell 11 is, for example, a lithium ion battery, a nickel-metal hydride battery, an all-solid-state battery, a lead-acid battery or the like.

The battery cell 11 has the electrode body 111 and the exterior body 112. The electrode body 111 has a positive electrode and a negative electrode. In detail, the electrode body 111 is composed of an active material of the positive electrode, an active material of the negative electrode, a current collector of the positive electrode, a current collector of the negative electrode, a separator, and the like. The exterior body 112 accommodates the electrode body 111 and an electrolyte, and has, for example, a rectangular shape. The exterior body 112 is made of a metallic material having good thermal conductivity. Examples of such metallic materials include aluminum, stainless steel, and nickel-plated steel. Wall portions constituting the exterior body 112 include wide side wall portions formed at both ends in the thickness direction (left-right direction in FIG. 1) of the battery cell 11, narrow side wall portions formed at both ends in the width direction (vertical direction in FIG. 3C) of the battery cell 11, an upper wall portion (lid), and a bottom wall portion. A positive electrode terminal which is electrically connected to the positive electrode of the electrode body 111, and a negative electrode terminal which is electrically connected to the negative electrode of the electrode body 111 are provided with the upper wall portion of the exterior body 112.

The cooler 12 is disposed so as to face the bottom surface 112A of the exterior body 112 (i.e., the lower surface of the bottom wall portion of the exterior body 112) to cool the battery cell 11. The cooler 12 is, for example, a cooling plate having a pipe through which a refrigerant (e.g., air, coolant, etc.) flows.

In another example, the cooler 12 may be one such as a heat sink, a heat dissipation fin, etc., that does not include the pipe for the refrigerant.

In the example shown in FIGS. 1 to 3C, the heat dissipation material 13 is disposed between the bottom surface 112A of the exterior body 112 of the battery cell 11 and the cooler 12. The heat dissipation material 13 is in contact with the bottom surface 112A of the exterior body 112 of the battery cell 11 and is in contact with the cooler 12. The heat dissipation material 13 functions as a heat transfer member, and the heat generated by the electrode body 111 of the battery cell 11 is conducted to the cooler 12 via the heat dissipation material 13. The heat dissipation material 13 includes a first member 131 having a first elongation, and a second member 132 having a second elongation higher than the first elongation. The hardness of the first member 131 is higher than the hardness of the second member 132, the adhesion of the first member 131 is stronger than the adhesion of the second member 132.

Specifically, in the example shown in FIGS. 1 to 3C, as the characteristics possessed by the first member 131, the thermal conductivity of the first member 131 is 3.0 [W/mK] or more, the hardness (Asker C: Asker rubber hardness meter C type) of the first member 131 is 85 to 95, the adhesion of the first member 131 is 1.3 [MPa] or more, and the elongation of the first member 131 is 10 [%] or more (less than 20 [%]). As the characteristics possessed by the second member 132, the thermal conductivity of the second member 132 is 3.0[W/mK] or more, the hardness (Asker C: Asker rubber hardness meter C type) of the second member 132 is 10 or less, the adhesion of the second member 132 is 0.01 [MPa] or more (1.3[MPa] or less), and the elongation of the second member 132 is 20 [%] or more.

In another example, the characteristics possessed by the first member 131 and the characteristics possessed by the second member 132 may be different from those described above.

In the example shown in FIGS. 1 to 3C, the bottom surface 112A of the exterior body 112 of the battery cell 11 is deformed into the convex shape to a side (a lower side in FIG. 2) of the cooler 12 and the heat dissipation material 13 by the heat generated by the electrode body 111, as shown in FIG. 2. That is, as shown in FIG. 2, in a state in which the bottom surface 112A is deformed into the convex shape, a top portion 112A1 and recesses 112A2 exist on the bottom surface 112A, each of the recesses 112A2 has less deformation amount (protrusion amount) to the side (lower side in FIG. 2) of the cooler 12 than the top portion 112A1.

Therefore, in the example shown in FIGS. 1 to 3C, the first member 131 of the heat dissipation material 13 is disposed in a position where the first member 131 is in contact with at least the top portion 112A1 of the bottom surface 112A of the exterior body 112 of the battery cell 11, the bottom surface 112A is deformed into the convex shape accompanied with the heat generation of the electrode body 111 of the battery cell 11. The second member 132 of the heat dissipation material 13 is disposed in a position where the second member 132 is adjacent to the first member 131 of the heat dissipation material 13 and the second member 132 is in contact with the recesses 112A2 of the bottom surface 112A of the exterior body 112 of the battery cell 11.

Specifically, in the example shown in FIGS. 1 to 3C, the first member 131 and the second member 132 of the heat dissipation material 13 are curable heat dissipation materials. As a method of applying the first member 131 and second member 132 of the heat dissipation material 13 to the cooler 12, a method using a general dispenser can be adopted. In particular, it is preferable to mix two liquids of a main agent and a curing agent just before application. In this method, since two liquids are mixed just before application, it is difficult to cure in an application step, and it is easy to store, and it is possible to quickly cure after application. In the heat dissipation structure 1 of the first embodiment, the first member 131 and the second member 132 are used as the heat dissipation material 13 (i.e., two types of materials are used as the heat dissipation material 13), it is preferable to apply the first member 131 and the second member 132 in order such as applying one of the first member 131 and second member 132 with a dispenser and then applying the other of the first member 131 and second member 132.

It is preferable that the sum of the contact area between the first member 131 and the bottom surface 112A of the exterior body 112 of the battery cell 11 and the contact area between the second member 132 and the bottom surface 112A of the exterior body 112 of the battery cell 11 is 90% or more of the total area of the bottom surface 112A of the exterior body 112 of the battery cell 11.

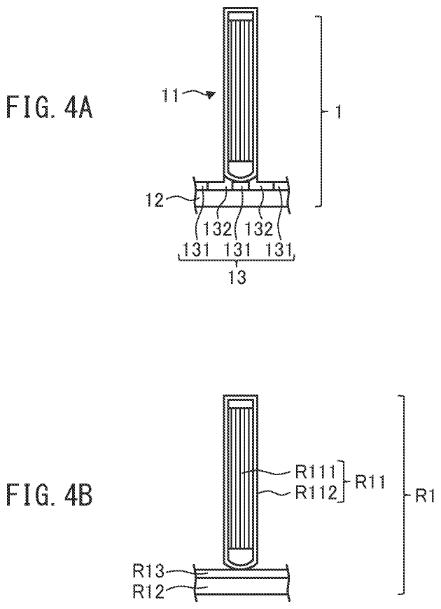

FIGS. 4A and 4B are diagrams showing the heat dissipation structure 1 of the first embodiment and the like in the state in which the bottom surface 112A of the exterior body 112 of the battery cell 11 is deformed into the convex shape accompanied with the heat generation of the electrode body 111 of the battery cell 11. Specifically, FIG. 4A shows an example of the heat dissipation structure 1 of the first embodiment in the state in which the bottom surface 112A of the exterior body 112 of the battery cell 11 is deformed into the convex shape accompanied with the heat generation of the electrode body 111 of the battery cell 11. FIG. 4B shows a heat radiation structure R1 of a comparative example in a state in which a bottom surface of an exterior body R112 of a battery cell R11 is deformed into a convex shape accompanied with the heat generation of an electrode body R111 of the battery cell R11. In the comparative example shown in FIG. 4B, since the hardness (Asker C: Asker rubber hardness meter C-type) of a heat dissipation material R13 is 80, the heat dissipation material R13 is hard, the heat dissipation material R13 cannot follow the deformation of the bottom surface of the exterior body R112 of the battery cell R11 accompanied with the heat generation of the electrode body R111 of the battery cell R11, the heat dissipation material R13 is peeled off from the bottom surface of the exterior body R112 of the battery cell R11. Consequently, the contact area between the bottom surface of the exterior body R112 of the battery cell R11 and the heat dissipation material R13 becomes small, the heat generated by the battery cell R11 cannot be sufficiently conducted to a cooler R12, there is a possibility that the heat dissipation becomes insufficient. On the other hand, in the example shown in FIG. 4A, since the hardness (Asker C: Asker rubber hardness meter C type) of the second member 132 of the heat dissipation material 13 is 10 or less, the second member 132 of the heat dissipation material 13 are soft, the second member 132 of the heat dissipation material 13 can follow the deformation of the bottom surface 112A of the exterior body 112 of the battery cell 11 accompanied with the heat generation of the electrode body 111 of the battery cell 11 without peeling from the recesses 112A2 of the bottom surface 112A of the exterior body 112 of the battery cell 11. In other words, the second member 132 of the heat dissipation material 13 can be complementary to the recesses 112A2 of the bottom surface 112A of the exterior body 112 of the battery cell 11 after the deformation accompanied with the heat generation of the electrode body 111 of the battery cell 11. Therefore, the contact area between the bottom surface 112A of the exterior body 112 of the battery cell 11 and the first member 131 and second member 132 of the heat dissipation material 13 is maintained without becoming small. As a result, the heat generated by the battery cell 11 is sufficiently conducted to the cooler 12, it is possible to perform the heat dissipation appropriately.

In the example of the heat dissipation structure 1 of the first embodiment, as shown in FIG. 4A, it is preferable that the contact area between the second member 132 and the bottom surface 112A of the exterior body 112 of the battery cell 11 is 50% or more of the total area of the bottom surface 112A of the exterior body 112 of the battery cell 11 so that the second member 132 of the heat dissipation material 13 follow the deformation of the bottom surface 112A of the exterior body 112 of the battery cell 11 accompanied with the heat generation of the electrode body 111 of the battery cell 11.

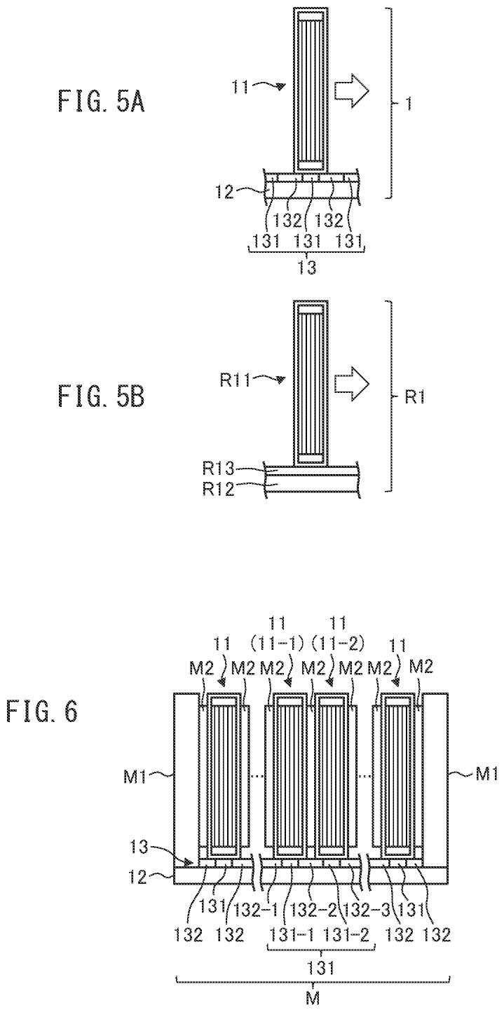

FIGS. 5A and 5B explains an example of the heat dissipation structure 1 of the first embodiment when an external input is applied, and the like. Specifically, FIG. 5A is a diagram for explaining the example of the heat dissipation structure of the first embodiment when the external input is applied. FIG. 5B is a diagram for explaining the heat dissipation structure R1 of the comparative example when the external input is applied.

In the comparative example shown in FIG. 5B, when an inertial force shown by a right arrow in FIG. 5B occurs in the battery cell R1 in accordance with the external input applied to the heat dissipation structure R11 of the comparative example, the battery cell R11 is prevented from being displaced in the right direction of FIG. 5B with respect to the cooler R12 by the strong adhesion possessed by the heat dissipation material R13. In the comparative example shown in FIG. 5B, similarly to the comparative example shown in FIG. 4B, the hardness (Asker C: Asker rubber hardness meter C-type) of the heat dissipation material R13 is 80.

In the example shown in FIG. 5A, when an inertial force shown by a right arrow in FIG. 5A occurs in the battery cell 11 in accordance with the external input applied to the heat dissipation structure 1 of the first embodiment, the battery cell 11 is prevented from being displaced in the right direction of FIG. 5A with respect to the cooler 12 by the strong adhesion possessed by the first member 131 of the heat dissipation material 13.

In the example of the heat dissipation structure 1 of the first embodiment, as shown in FIG. 5A, it is preferable that the contact area between the first member 131 and the bottom surface 112A of the exterior body 112 of the battery cell 11 is 37% or more of the total area of the bottom surface 112A of the exterior body 112 of the battery cell 11 in order to prevent the battery cell 11 from being displaced in the right direction of FIG. 5A with respect to the cooler 12 when the external input is applied to the heat dissipation structure 1 of the first embodiment.

In the example of the heat dissipation structure 1 of the first embodiment, it is preferable that a ratio of the area of the contact surface between the first member 131 of the heat dissipation material 13 and the cooler 12 to the area of the contact surface between the second member 132 of the heat dissipation material 13 and the cooler 12 is e.g. 4/6 to 6/4.

In the example of the heat dissipation structure 1 of the first embodiment, as a filler for ensuring the thermal conductivity of the first member 131 and the second member 132 of the heat dissipation material 13, aluminum hydroxide and/or aluminum oxide is preferably used. Since aluminum hydroxide and aluminum oxide have high thermal conductivity and low specific gravity, it is possible to suppress a resin component as a filling material contained in the first member 131 and the second member 132 and the filler from being separated from each other. The shape of the filler included in the first member 131 and the second member 132 is preferably spherical so that the filler can be filled with a high filling factor while avoiding a decline in fluidity of the filler.

In the example of the heat dissipation structure 1 of the first embodiment, the resin component as the filling material included in the first member 131 and second member 132 of the heat dissipation material 13 is preferably an addition reaction type liquid polymer. The addition reaction type liquid polymer has small curing shrinkage.

When the first member 131 and the second member 132 of the heat dissipation material 13 are cured in a state of being sandwiched between the battery cell 11 and the cooler 12, if the curing shrinkage of the first member 131 and the second member 132 is large, a gap may occur between the battery cell 11 and the first member 131 and the second member 132, or between the cooler 12 and the first member 131 and the second member 132.

In view of this point, in the example of the heat dissipation structure 1 of the first embodiment, the resin component as the filling material contained in the first member 131 and the second member 132 is the addition reaction type liquid polymer and has small curing shrinkage. Therefore, it is possible to suppress a gap formed between the battery cell 11 and the first member 131 and second member 132, and to suppress a gap formed between the cooler 12 and the first member 131 and second member 132. Examples of the addition reaction type liquid polymer used for the resin component as the filling material contained in the first member 131 and the second member 132 of the heat dissipation material 13 include for example polyurethane, an epoxy resin, an olefin polymer, silicone, etc.

In the example of the heat dissipation structure 1 of the first embodiment, a dispersant, a flame retardant, a coupling agent, a plasticizer, an antioxidant, a colorant, a catalyst, or the like may be added to the heat dissipation material 13 of the curing type. When those described above are added to the heat dissipation material 13 of the cure type, by mixing those described above to the heat dissipation material 13 of the curing type, the heat dissipation material 13 of the curing type to which those described above is added is manufactured.

In the example of the heat dissipation structure 1 of the first embodiment shown in FIGS. 4A and 5A, the heat dissipation material 13 includes the first member 131 having the first elongation and the second member 132 having the second elongation higher than the first elongation. The hardness of the first member 131 is higher than the hardness of the second member 132, the adhesion of the first member 131 is stronger than the adhesion of the second member 132. Therefore, when the heat is (abnormally) generated by the electrode body 111 of the battery cell 11, the second member 132 having the second elongation higher than the first elongation (i.e., the soft second member 132) follow the deformation of the bottom surface 112A of the exterior body 112 of the battery cell 11 accompanied with the heat generation of the electrode body 111 of the battery cell 11, and are in contact with the recesses 112A2 of the bottom surface 112A of the exterior body 112 of the battery cell 11. Further, when the external input is applied to the heat dissipation structure 1, the high-hardness and strong adhesion of the first member 131 can prevent the battery cell 11 from being displaced in the right direction of the FIG. 5A with respect to the cooler 12.

That is, in the example of the heat dissipation structure 1 of the first embodiment, the physical properties of the heat dissipation material 13 required at the time of the (abnormal) heat generation of the electrode body 111 of the battery cell 11 and the physical properties of the heat dissipation material 13 required when the external input is applied to the heat dissipation structure 1 can be satisfied at the same time.

In the examples shown in FIGS. 3A to 3C, 4A and 5A, the heat dissipation material 13 includes the second member 132 on both sides of the central first member 131, but in another example, the heat dissipation material 13 may include the second member 132 only on one side of the central first member 131.

### Second Embodiment

The heat dissipation structure 1 included in a battery module M of a second embodiment is configured similarly to the heat dissipation structure 1 of the first embodiment described above, except for the point to be described later.

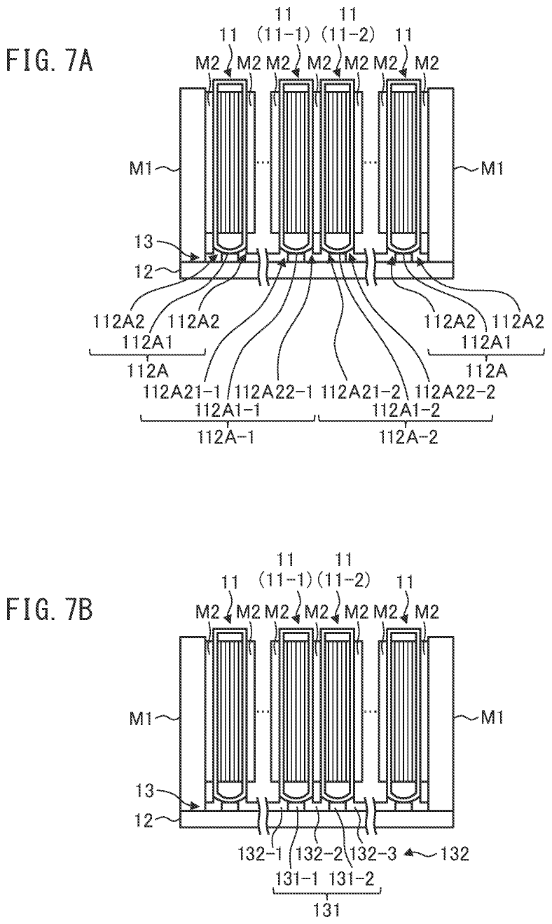

FIG. 6 is a diagram schematically showing an example of the battery module M of the second embodiment. Specifically, FIG. 6 shows a condition in which the deformation of the bottom surfaces 112A of the exterior bodies 112 of the plurality of battery cells 11 accompanied with the heat generation of the electrode bodies 111 of the plurality of battery cells 11 (11-1, 11-2) included in the battery module M of the second embodiment does not occur. FIGS. 7A and 7B are diagrams for explaining the top portions 112A1, the recesses 112A2 and the like of the bottom surfaces 112A of the exterior bodies 112 in a state where the bottom surfaces 112A of the exterior bodies 112 of the plurality of battery cells 11 are respectively deformed into the convex shape accompanied with the heat generation of the electrode bodies 111 of the plurality of battery cells 11 included in the battery module M of the second embodiment. Specifically, FIG. 7A shows the top portions 112A1(112A1-1, 112A1-2), the recesses 112A2(112A21-1, 112A22-1, 112A21-2, 112A22-2), and the like of the bottom surfaces 112A(112A-1, 112A-2) of the exterior bodies 112 in the state in which the bottom surfaces 112A of the exterior bodies 112 of the plurality of battery cells 11 are respectively deformed into the convex shape accompanied with the heat generation of the electrode bodies 111 of the plurality of battery cells 11 included in the battery module M of the second embodiment. FIG. 7B shows the first member 131 (131-1, 131-2), the second member 132 (132-1, 132-2, 132-3), and the like of the heat dissipation material 13 in the state in which the bottom surfaces 112A of the exterior bodies 112 of the plurality of battery cells 11 are respectively deformed into the convex shape accompanied with the heat generation of the electrode bodies 111 of the plurality of battery cells 11 included in the battery module M of the second embodiment.

In the example shown in FIGS. 6, 7A and 7B, the battery module M of the second embodiment has the heat dissipation structure 1 shown in FIG. 3A. The battery module M includes the plurality of battery cells 11, the cooler 12 for cooling the plurality of battery cells 11, the heat dissipation material 13 disposed between the plurality of battery cells 11 and the cooler 12, and endplates M1. The plurality of battery cells 11 are arranged side by side. Heat insulators M2 have a function of suppressing transfer of heat generated by one battery cell 11 of the plurality of battery cells 11 from the one battery cell 11 to the other battery cells 11 which are adjacent to the one battery cell 11 at the time of abnormal heat generation of the one battery cell 11, for example. The heat generated by the one battery cell 11 is released to the cooler 12 through the heat dissipation material 13.

In the battery module M of the second embodiment, as shown in FIG. 7A, when the bottom surfaces 112A of the exterior bodies 112 of the plurality of battery cells 11 are respectively deformed into the convex shape accompanied with the heat generation of the electrode bodies 111 of the plurality of battery cells 11, the top portions 112A1(112A1-1, 112A1-2) of the plurality of battery cells 11 are in contact with the first member 131 of the heat dissipation material 13. In other words, in the example shown in FIG. 6, 7A and 7B, the heat dissipation material 13 has the same number of portions of the first member 131 as the plurality of battery cells 11.

Furthermore, in the battery module M of the second embodiment, as shown in FIGS. 7A and 7B, when the bottom surfaces 112A of the exterior bodies 112 of the plurality of battery cells 11 are respectively deformed into the convex shape accompanied with the heat generation of the electrode bodies 111 of the plurality of battery cells 11, the recesses 112A2(112A21-1, 112A22-1, 112A21-2, 112A22-2) of the bottom surfaces 112A of the exterior bodies 112 of the plurality of battery cells 11 are respectively in contact with the second member 132 of the heat dissipation material 13.

In the example shown in FIGS. 6, 7A and 7B, the plurality of battery cells 11 included in the battery module M includes a first battery cell 11-1 and a second battery cell 11-2 arranged side by side with the first battery cell 11-1. As shown in FIG. 7A, the bottom surface 112A-1 of the first battery cell 11-1 includes the top portion 112A1-1 of the first battery cell 11-1, a first recess 112A21-1 of the first battery cell 11-1 located on an opposite side (left side in FIG. 7A) of the second battery cell 11-2 across the top portion 112A1-1 of the first battery cell 11-1, and a second recess 112A22-1 of the first battery cell 11-1 located on a side (right side in FIG. 7A) of the second battery cell 11-2 from the top portion 112A1-1 of the first battery cell 11-1. The bottom surface 112A-2 of the second battery cell 11-2 includes the top portion 112A1-2 of the second battery cell 11-2, a first recess 112A21-2 of the second battery cell 11-2 located on a side (left side of FIG. 7A) of the first battery cell 11-1 from the top portion 112A1-2 of the second battery cell 11-2, and a second recess 112A22-2 of the second battery cell 11-2 located on an opposite side (right side of FIG. 7A) of the first battery cell 11-1 across the top portion 112A1-2 of the second battery cell 11-2. As shown in FIG. 7B, the first member 131 of the heat dissipation material 13 includes a first portion 131-1 of the first member 131 that is in contact with the top portion 112A1-1 of the first battery cell 11-1 and a second portion 131-2 of the first member 131 that is in contact with the top portion 112A1-2 of the second battery cell 11-2. The second member 132 of the heat dissipation material 13 includes a first portion 132-1 of the second member 132 that is in contact with the first recess 112A21-1 (see FIG. 7A) of the first battery cell 11-1, a second portion 132-2 of the second member 132 that is in contact with the second recess 112A22-1 (see FIG. 7A) of the first battery cell 11-1 and is in contact with the first recess 112A21-2 (see FIG. 7A) of the second battery cell 11-2, and a third portion 132-3 of the second member 132 that is in contact with the second recess 112A22-2 (see FIG. 7A) of the second battery cell 11-2. That is, in the example shown in FIGS. 6, 7A and 7B, the second portion 132-2 of the second member 132 of the heat dissipation material 13 is commonly used by the first battery cell 11-1 and the second battery cell 11-2.

In the battery module of the comparative example in which the heat dissipation material of the sheet type is used, the heat dissipation material cannot absorb the dimensional tolerance that the plurality of battery cells have. Further, since the compressive stress at the time of assembling the plurality of battery cells and the heat dissipation material is high, if it is attempted to compress the heat dissipation material by pressing the plurality of battery cells to the heat dissipation material, it is impossible to compress the heat dissipation material to a target thickness.

On the other hand, in the example of the battery module M of the second embodiment, it is possible to compress the heat dissipation material 13 by pressing the plurality of battery cells 11 to the heat dissipation material 13 because the heat dissipation material 13 is curable, the dimensional tolerance which the plurality of battery cells 11 have can be absorbed by the heat dissipation material 13.

### First Example

Study results on the first member 131 and second member 132 of the heat dissipation material 13 concerning the external input are shown below. As the first member 131, a two-part curing urethane-based heat dissipation material made by Dupont having the following properties was used. The thermal conductivity is 3.0[W/mK], the hardness (Asker C: Asker rubber hardness meter type C) is 87, the adhesion is 1.3[MPa], and the elongation is 10 [%]. As the second member 132, a two-part curing silicone-based heat dissipation material made by Wacker AsahiKasei Silicone having the following characteristics was used. The thermal conductivity is 3.0[W/mK], the hardness (Asker C: Asker rubber hardness meter type C) is 10, the adhesion is 0.01[MPa], and the elongation is 20 [%].

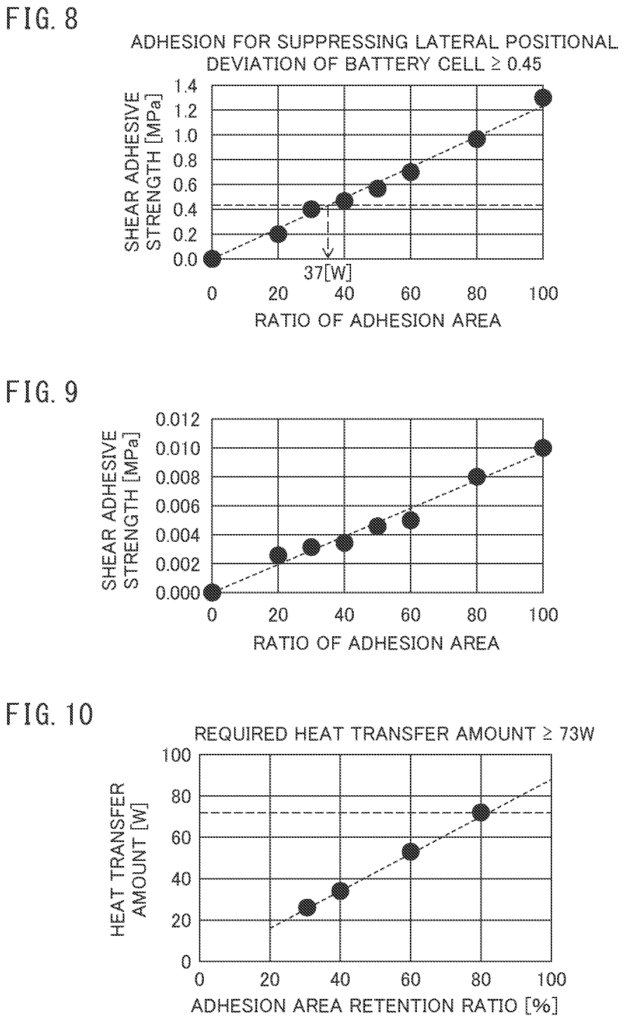

FIG. 8 is a diagram showing a relationship between an area ratio (ratio of adhesion area) of the first member 131 and a shear adhesion (shear adhesive strength [MPa]) of the first member 131. FIG. 9 is a diagram showing a relationship between an area ratio (ratio of adhesion area) of the second member 132 and a shear adhesion (shear adhesive strength [MPa]) of the second member 132. Since the lateral force is applied to the battery cell 11 when the external input is applied, the shear adhesion was confirmed by performing a tensile test (tensile shear adhesive strength test: JIS K 6850). In the tensile test, the dimensions of the first member 131 and second member 132 were set to 25 mm×12.5 mm×thickness 2.0 mm, and the tensile speed was set to 50 mm/min. As shown in FIG. 8, the shear adhesion required to suppress the lateral positional deviation of the battery cell 11 by the first member 131 is 0.45 MPa or more, the adhesion area between the bottom surface 112A of the exterior body 112 of the battery cell 11 is 37% or more. As shown in FIG. 9, since shear adhesion is less than 0.45 MPa even if the adhesion area between the second member 132 and the bottom surface 112A of the exterior body 112 of the battery cell 11 is set to 100%, it was found that the lateral positional deviation of the battery cell 11 cannot be suppressed by only the second member 132.

### Second Example

Study results on the first member 131 and the second member 132 of the heat dissipation material 13 concerning the abnormal heat generation of the battery cell 11 are shown below.

It was found that the required heat transfer property cannot be ensured if the heat dissipation material 13 is constituted only by the first member 131, because the recesses 112A2 of the bottom surface 112A of the exterior body 112 of the battery cell 11 are peeled off from the first member 131, and the contact area between the bottom surface 112A of the exterior body 112 of the battery cell 11 and the first member 131 is reduced to 30 [%], when the bottom surface 112A of the exterior body 112 of the battery cell 11 is deformed into the convex shape accompanied with the heat generation of the electrode body 111 of the battery cell 11.

FIG. 10 is a diagram showing a relationship between a contact area retention ratio [%] between the bottom surface 112A of the exterior body 112 of the battery cell 11 and the first member 131 and a heat transfer amount [W] to the cooler 12 via the first member 131. As shown in FIG. 10, when the bottom surface 112A of the exterior body 112 of the battery cell 11 is deformed into the convex shape (at the time of the abnormal heat generation of the battery cell), the heat transfer amount to the cooler 12 via the first member 131 is required to be 73 [W] or more, and therefore, it was found that the contact area retention ratio between the bottom surface 112A of the exterior body 112 of the battery cell 11 and the first member 131 is required to be 80 [%] or more.

From the above-described findings, it has been found that, when the thermal conductivity of the first member 131 is equal to the thermal conductivity of the second member 132, the ratio of the first member 131 of the heat dissipation material 13 needs to be 37% or more in order to suppress the lateral positional deviation of the battery cell 11 when the lateral force is applied to the battery cell 11 (the heat dissipation structure 1), and the ratio of the second member 132 of the heat dissipation material 13 needs to be 50% (80% to 30%) in order to ensure the heat transfer property to the cooler 12 via the heat dissipation material 13 when the bottom surface 112A of the exterior body 112 of the battery cell 11 is deformed into the convex shape (at the time of the abnormal heat generation of the battery cell).

As described above, although the embodiments of the heat dissipation structure and the battery module of the present disclosure have been described with reference to the drawings, the heat dissipation structure and the battery module of the present disclosure are not limited to the embodiments described above, and appropriate changes can be made without departing from the scope of the present disclosure. The configuration of each example of the embodiment described above may be appropriately combined.

1. A heat dissipation structure comprising:
a battery cell having an electrode body and an exterior body configured to accommodate the electrode body;
a cooler disposed so as to face a bottom surface of the exterior body; and
a heat dissipation material disposed between the bottom surface and the cooler, and being in contact with the bottom surface and the cooler, wherein
the bottom surface is deformed into a convex shape to a side of the cooler and the heat dissipation material by the heat generated by the electrode body,
the heat dissipation material includes a first member having a first elongation, and a second member having a second elongation higher than the first elongation,
the first member is disposed in a position where the first member is in contact with at least a top portion of the bottom surface deformed into the convex shape,
the second member is disposed in a position where the second member is adjacent to the first member and the second member is in contact with a recess of the bottom surface, the recess has less deformation amount to the side of the cooler than the top portion.

2. The heat dissipation structure according to claim 1, wherein
the first member has hardness higher than the second member,
the first member has adhesion stronger than the second member.

3. A battery module including the heat dissipation structure according to claim 1, wherein
a plurality of battery cells is arranged side by side,
the top portion of each of the plurality of battery cells is in contact with the first member,
the recess of each of the plurality of battery cells is in contact with the second member.

4. The heat dissipation structure according to claim 1, wherein
a ratio of an area of a contact surface between the first member and the cooler to an area of a contact surface between the second member and the cooler is 4/6 to 6/4.

5. The battery module according to claim 3, wherein
the plurality of battery cells includes at least a first battery cell and a second battery cell arranged side by side with the first battery cell,
the bottom surface of the first battery cell includes the top portion of the first battery cell, a first recess of the first battery cell located on an opposite side of the second battery across the top portion of the first battery cell, and a second recess of the first battery located on a side of the second battery from the top portion of the first battery cell,
the bottom surface of the second battery cell includes the top portion of the second battery cell, a first recess of the second battery cell located on a side of the first battery from the top portion of the second battery cell, and a second recess of the second battery located on an opposite side of the first battery across the top portion of the second battery cell,
the first member includes at least a first portion of the first member being in contact with the top portion of the first battery cell and a second portion of the first member being in contact with the top portion of the second battery cell,
the second member includes at least a first portion of the second member being in contact with the first recess of the first battery cell, a second portion of the second member being in contact with the second recess of the first battery cell and the first recess of the second battery cell, and a third portion of the second member being in contact with the second recess of the second battery cell.
